(19) United States
(12) Patent Application Publication
(10) Pub. No.: US 2002/0035966 A1
(43) Pub. Date: Mar. 28, 2002

(54) IMPLEMENT FOR SHAVING ANIMALS

(76) Inventors: CORNELIS VAN DER LELY, ZUG (CH); OLAF VAN DER LELY, ZUG (CH)

Correspondence Address: PENROSE LUCAS ALBRIGHT, MASON, MASON & ALBRIGHT, POBOX 2246, ARLINGTON, VA, 222020246

(21) Appl. No.: 09/226,008

(22) Filed: Jan. 6, 1999

(30) Foreign Application Priority Data
Jul. 5, 1997 (NL) 1006004
Jan. 5, 1998 (NL) PCT/NL98/00243

(51) Int. Cl. A01J 3/00; A01J 5/00

(52) U.S. Cl. 119/14.18

(57) ABSTRACT

An apparatus for automatically shaving animals' udder and part of their legs while they are in a milking compartment for automatically milking animals. A shaving device is movably connected to one side of the milking compartment and is movable both transversely and longitudinally as well as vertically relative to the milking compartment for automatically shaving animals in a period of about 30 seconds in preselected areas in the vicinity of their udders and hind legs. The shaving machine has a robot arm with a shaver provided on its end. The shaving machine is preferably hingeably connected to the side of the milking compartment and its operations are controlled by a computer so that animals identified by an identification system are shaved, say, every tenth time that they enter the milking compartment to be milked therein, or are shaved therein after a selected duration of time after being previously shaved in the milking compartment. The same detector used for locating the animal' teats for the automatic milking operation is used for detecting the locations of the areas of the animal to be shaved.

### FIELD OF INVENTION

The invention relates to an implement or apparatus for shaving animals, such as cows, wherein the apparatus comprises one or more accommodations or compartments for automatically milking animals wherein the animals are confined, the milking compartment being provided with a shaving device for automatically shaving each animal at least in the vicinity of the animal' udder.

### BACKGROUND OF THE INVENTION

Implements for shaving animals prior to milking are known. In such known implement the animals are shaved manually by means of a shaver. With cows, usually the udder and the hind legs are shaved in order to prevent dirt from sticking thereto.

Shaving the animals manually by means of a shaver is a time-consuming and unpleasant job.

The invention aims to provide an implement which is automatic shaving apparatus as described above, in which the aforesaid drawbacks do not occur are at least minimized.

### SUMMARY OF THE INVENTION

According to the invention, this is achieved in that the shaving device comprises a shaving machine for shaving the animals automatically whereby an operating person is no longer required.

According to an inventive feature, a shaving machine having a robot arm on one end of such a shaver is provided. Therefore, the invention further relates to an implement for shaving animals, such as cows, which implement comprises one or more compartments where the animals are automatically milked, broadly accommodations where the animals are confined prior to milking, and which implement is provided with a shaving device, characterized in that the shaving device comprises a shaving machine having a robot arm which has an end that is provided with a shaver. Compartments for automatically milking animals are well-known in the art as disclosed in U.S. Pat. No. 5,042,428, for example. In the preferred embodiment of the invention, the shaving machine is disposed near a side wall of the accommodation. If cows have to be shaved, the shaving machine is arranged near the place where the udder is located when the animal has entered the accommodation. According to a further inventive feature, the shaving machine is provided with displacing means with the aid of which the shaver can be moved from outside the accommodation towards the animal to be shaved or vice versa. Therefore, the invention also relates to an implement for shaving animals, such as cows, comprising one or more accommodations for holding the animals wherein the implement is provided with a shaving device, characterized in that the shaving device comprises a shaving machine provided with displacing means with the aid of which a shaver being part of the shaving machine can be moved from outside the accommodation towards the animal to be shaved or vice versa.

In accordance with a further aspect of the invention, the displacing means comprise displacing elements, such as stepper motors or servo-pneumatic or hydraulic pistons and cylinders by means of which the shaver can be moved vertically relative to accommodation as well as in the longitudinal and transverse directions thereof. The displacing elements make it possible to shave almost every place of an animal's skin.

According to a further inventive feature, the shaver comprises a housing provided with a shaving head having a stationary upper knife that cooperates with a motor-driven lower knife disposed thereunder. In a preferred embodiment of the invention, the upper knife is designed as a semi-bowl-shaped cutting member, while the lower knife comprises a plurality of knives that are fitted at some distance from each other to a shaft of the motor of the shaver. According to an inventive feature, the knives are designed as circle segments having an included angle of approximately 90°.

For the purpose of cleaning the shaver, according to an inventive feature, the upper knife is detachably disposed on the housing of the shaver. According to again another inventive feature, the implement comprises a computer for automatically controlling the shaving device. In accordance with an inventive feature, the computer contains a program in which the coordinates of the surface to be shaved of the animal are stored. For the purpose of determining which animal is present in the accommodation, in accordance with an inventive feature, the implement comprises an animal identification system. With the aid of the identification system and the computer, the correct coordinates of the surface to be shaved can be determined for the relevant animal. According to again another inventive feature, the implement comprises time adjusting means which include a first program by means of which, in an animal-dependent manner if so desired, the shaving time can be adjusted. In a preferred embodiment of the invention, the shaving time of the udder preferably amounts to thirty seconds. According to again another aspect of the invention, the time adjusting means include a second program by means of which, in an animal-dependent manner if so desired, the interval between two shaving runs can be adjusted.

In accordance with another embodiment of the invention, the time adjusting means include a second program by means of which, in an animal-dependent or group-dependent manner, the number of milking runs after the last shaving operation is determined, and in which it is possible to pre-set, in an animal-dependent or group-dependent manner, the number of milking runs after the animal or the group of animals has to be shaved again. The second embodiment is particularly suitable if shaving takes place before or after milking. In a further embodiment of the invention, the number of pre-set milking runs preferably amounts to ten.

Besides the fact that the coordinates of the surface to be shaved can be inputted into the computer, according to another inventive feature, it is additionally possible to provide the implement with detection means with the aid of which the coordinates of the part to be shaved of the animal can be determined. According to an inventive feature, the detection means comprises a sensor, such as a laser and/or a camera and/or an ultrasonic sensor and/or any other suitable sensor.

In a preferred embodiment according to the invention, the implement is also provided with an automatic milking device. By shaving the udder periodically prior to milking, it is possible to work very hygienically, which has a positive effect on the milk quality. According to again another inventive feature, the automatic milking device is provided with a milking robot for automatically connecting the teat cups to the teats of an animal to be milked. Because of this, both milking and shaving can take place fully automatically without an operating person being required.

Therefore, the invention furthermore relates to an implement for shaving animals, such as cows, comprising one or more accommodations, provided with a shaving device, characterized in that the shaving device comprises a shaving machine for automatically shaving animals and which implement is also provided with an automatic milking device including a milking robot for automatically connecting teat cups to the teats of an animal to be milked. In accordance with an inventive feature, the aforementioned detection means can also be used for determining the coordinates of the teats for the milking robot.

The invention furthermore relates to a method of automatically shaving animals, in which, after an animal has entered an accommodation, the animal or at least a predetermined part of the animal is shaved by means of a shaving machine. According to an inventive feature, during shaving the shaver is moved across the surface to be shaved. According to a further aspect of the invention, after the shaving operation has ended, the shaver is moved to outside the accommodation.

### BRIEF DESCRIPTION OF THE DRAWINGS

For a better understanding of the invention, reference will now be made to an embodiment shown in the accompanying drawings, in which:

FIG. 1 is a rear view of an udder wherein a shaving device for shaving the udder arranged there below; and

FIG. 2 is a plan view according to the arrow II in FIG. 1 of the shaving head of the shaving device.

### DETAILED DESCRIPTION OF THE PREFERRED EMBODIMENT

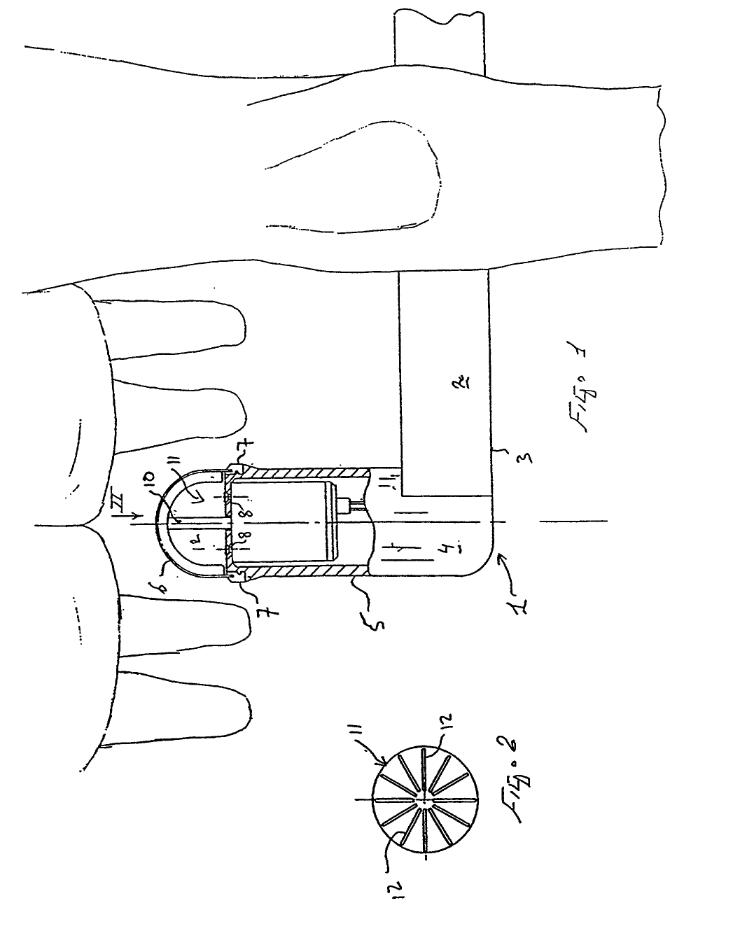

FIG. 1 represents part of a shaving device 1 for automatically shaving animals (partially showing the interior thereof). The shaving device 1 comprises a shaving machine 2 which is not shown in its entirety. Shaving machine 2 has a robot arm 3 which is provided with a shaver 4 at its end. Shaving machine 2 is hingeably disposed near a side wall of an accommodation such is a milking compartment for the animal.

Shaver 4 comprises a cylindrical housing 5 which is provided at its upper side with a shaving head. The shaving head comprises a stationary upper knife 6 which is designed in the present embodiment as a semi-bowl-shaped cutter member. The shaving head is fastened to housing 5 by means of detachable connections 7. This makes it possible to clean or to repair shaver 4 on the inside. By means of screws 8, an electric motor 9, provided with a shaft 10, is disposed in cylindrical housing 5. Under the shaving head there is disposed a lower knife 11 which cooperates with the knife 6. As shown in FIG. 32, lower knife 11 comprises plurality of knives 12, which are fitted at some distance from each other to shaft 10 of electric motor 9. Knives 12 are designed as segments of a circle having an interior angle of approximately 90°.

The function of the above described implement is as follows:

After an animal has entered an accommodation, the animal is identified by the animal identification system. With the aid of timing means the time interval is determined between the moment when the animal enters the accommodation and the last time the animal was shaved. If the interval has exceeded a predetermined threshold, a computer decides that the animal is to be shaved. With the aid of detection means the coordinates of the part of the animal to be shaved are determined. On the basis of these coordinates, displacing means comprising displacing elements are activated in order that robot arm 3 including shaver 4 is moved to position the animal to be shaved. Subsequently electric motor 9 is energized so that lower knife 11 starts rotating. Then, the shaving head is moved in a reciprocating manner across the surface to be shaved by means of robot arm 3. In a preferred embodiment of the invention, there is recorded in the computer that the shaving time amounts to approximately thirty seconds. After the surface has been shaved, shaver 14 is pivoted to outside the accommodation and electric motor 9 is deactivated. In the preferred embodiment of the invention, the implement comprises an automatic milking device including a milking robot. After the udder or legs or both of the animal have been shaved, with the aid of the detection means the position of the teats of the animal to be milked is determined. By means of the milking robot, subsequently teat cups are connected to the teats of the animal to be milked, after which the animal is milked automatically. Because the udder or the legs or both of the animal have been shaved before milking, it is possible to milk very hygienically inasmuch as dirt will not stick to the hairs of the animal during milking. If the above-mentioned shaving device 1 cooperates with the milking robot, the timing means includes a program in which, in an animal-dependent manner, the number of milking runs after the last shaving operation is determined. It is inputted into the program that the animal is to be shaved again after ten milking runs.

Although we have disclosed the preferred embodiment of our invention, it is to be understood that it is capable of other adoptions and modifications within the scope of the following claims.

1. An implement for shaving animals, such as cows, which implement comprises one or more accommodations where the animals can stay and is provided with a shaving device (1), characterized in that the shaving device comprises a shaving machine (2) for automatically shaving the animals.

2. An implement as claimed in claim 1, characterized in that the shaving machine (2) has at least one robot arm (3) which is provided with a shaver (4).

3. An implement for shaving animals, such as cows, which implement comprises one or more accommodations where the animals can stay and is provided with a shaving device (1), characterized in that the shaving device comprises a shaving machine (2) having a robot arm (3).

4. An implement as claimed in any one of the preceding claims, characterized in that the shaving machine (2) is hingeably disposed near a wall of the accommodation of an animal.

5. An implement as claimed in claim 4, characterized in that the shaving machine (2) is provided with displacing means with the aid of which the shaver (4) can be moved from an operative position into an inoperative position.

6. An implement for shaving animals, such as cows, which implement comprises one or more accommodations where the animals can stay and is provided with a shaving device (1), characterized in that the shaving device comprised a shaving machine (2) provided with displacing means with the aid of which the shaver (4) can be moved from an operative position into an inoperative position.

7. An implement as claimed in any one of the preceding claims, characterized in that the displacing means of the implement comprise displacing elements, such as stepper motors or servo-pneumatic or hydraulic cylinders by means of which the shaver (4) can be moved in the upward direction of the accommodation as well as in the longitudinal and transverse direction thereof.

8. An implement as claimed in any one of the preceding claims, characterized in that the shaver (4) comprises a housing (5) provided with a shaving head having a stationary upper knife (6) that cooperates with a motor-driven lower knife (11) disposed thereunder.

9. An implement as claimed in any one of the preceding claims, characterized in that the upper knife (6) is designed as a semi bowl-shaped cutting member.

10. An implement as claimed in any one of the preceding claims, characterized in that the lower knife (11) comprises a number of knives (12) that are fitted at some distance from each other.

11. An implement as claimed in any one of the preceding claims, characterized in that the knives (12) are designed as circle segments having an angle of approximately 90°.

12. An implement as claimed in any one of the preceding claims, characterized in that the upper knife (6) is detachably disposed on the housing (5) of the shaver (4).

13. An implement as claimed in any one of the preceding claims, characterized in that the implement comprises a computer for automatically controlling the shaving device (1).

14. An implement as claimed in any one of the preceding claims, characterized in that the computer contains a program in which the coordinates of the surface to be shaved of the animal are stored.

15. An implement as claimed in any one of the preceding claims, characterized in that the implement comprises an animal identification system.

16. An implement as claimed in any one of the preceding claims, characterized in that the implement comprises time adjusting means which include a first program by means of which, in an animal-dependent manner if so desired, the shaving time can be adjusted.

17. An implement as claimed in any one of the preceding claims, characterized in that the shaving time preferably amounts to 30 seconds.

18. An implement as claimed in any one of the preceding claims, characterized in that the time adjusting means include a second program by means of which, in an animal-dependent manner if so desired, the interval between two shaving runs can be adjusted.

19. An implement as claimed in any one of the preceding claims, characterized in that the number of pre-set milking runs preferably amounts to ten.

20. An implement as claimed in any one of the preceding claims, characterized in that the implement is provided with detection means with the aid of which the coordinates of the part to be shaved of the animal can be determined.

21. An implement as claimed in any one of the preceding claims, characterized in that the detection means comprise a sensor, such as a laser and/or a camera and/or an ultrasonic sensor.

22. An implement as claimed in any one of the preceding claims, characterized in that the implement is provided with an automatic milking device.

23. An implement as claimed in any one of the preceding claims, characterized in that the automatic milking device is provided with a milking robot for automatically connecting teat cups to the teats of an animal to be milked.

24. An implement for shaving animals, such as cows, which implement comprises one or more accommodations where the animals can stay and is provided with a shaving device (1), characterized in that the shaving device comprises a shaving machine (2) for automatically shaving the animals, and the implement is further provided with a milking robot for automatically connecting teat cups to the teats of an animal to be milked.

25. An implement as claimed in any one of the preceding claims, characterized in that the detections means can also be used for the milking robot.

26. An implement as claimed in any one of the preceding claims, characterized in that the shaving head comprises a stationary upper knife (6) and a rotating lower knife (11).

27. An implement as claimed in any one of the preceding claims, characterized in that the implement is designed in such a manner that by means of the shaving device (1) the udder and the hind legs of a cow can be shaved.

28. An implement as claimed in any one of the preceding claims, characterized in that the implement has a carrier arm for displacing the shaving head into and out of the working area and for moving the shaving head in a reciprocating manner.

29. An implement as claimed in any one of the preceding claims, characterized in that the shaving head can be moved automatically into an inoperative position.

30. An implement as claimed in any one of the preceding claims, characterized in that the teat cups are movable into the inoperative position.

31. An implement as claimed in any one of the preceding claims, characterized in that after e.g. ten milking runs the udder is shaved one time.

32. An implement as claimed in any one of the preceding claims, characterized in that after shaving the shaving device is moved into the inoperative position near a wall.

33. An implement as claimed in any one of the preceding claims, characterized in that the shaving device is adjustable in such a manner that shaving takes 30 seconds.

34. An implement as claimed in any one of the preceding claims, characterized in that the shaving device utilizes the same laser detector as is used for milking.

35. A method of automatically shaving animals, in which, after an animal has entered an accommodation, the animal or at least a possibly predetermined part of the animal is shaved automatically by means of a shaving machine.

36. A method as claimed in claim 27, characterized in that during shaving the shaver (4) is moved across the surface to be shaved in a reciprocating manner.

37. A method as claimed in claim 27 or 28, characterized in that, after the shaving operation has ended, the shaver (4) is moved to outside the accommodation.
